(19) United States
(12) Patent Application Publication
(10) Pub. No.: US 2025/0037922 A1
(43) Pub. Date: Jan. 30, 2025

(54) COIL COMPONENT

(71) Applicant: Murata Manufacturing Co., Ltd., Kyoto-fu (JP)

(72) Inventors: Masaki KITAJIMA, Nagaokakyo-shi (JP); Yoshitaka MURAKAMI, Nagaokakyo-shi (JP)

(73) Assignee: Murata Manufacturing Co., Ltd., Kyoto-fu (JP)

(21) Appl. No.: 18/783,364

(22) Filed: Jul. 24, 2024

(30) Foreign Application Priority Data
Jul. 28, 2023 (JP) 2023-123051

(51) Int. Cl. H01F 27/26; H01F 5/02

(52) U.S. Cl. CPC H01F 27/263; H01F 2005/022

(57) ABSTRACT

A coil component includes a drum core as a first core and a top plate as a second core. The coil component also includes a wire and an adhesive. The adhesive includes a bisphenol F resin, magnetic powder, and a curing agent. A cross section perpendicular to an adhesion surface between the adhesive and the drum core is set to a specific cross section. A direction perpendicular to the adhesion surface is set to a thickness direction. A direction perpendicular to the thickness direction in the specific cross section is set to an extending direction. The adhesive includes a resin portion in the specific cross section. The resin portion is a portion which does not contain the magnetic powder in the thickness direction in a range between the drum core and the top plate and which is continuously disposed by 3 μm or larger in the extending direction.

### CROSS-REFERENCE TO RELATED APPLICATION

This application claims benefit of priority to Japanese Patent Application No. 2023-123051, filed Jul. 28, 2023, the entire content of which is incorporated herein by reference.

### BACKGROUND

### Technical Field

The present disclosure relates to a coil component.

### Background Art

A coil component disclosed in U.S. Patent Application Publication No. 2013/229254 includes a core. The core includes a winding core and two flanges. The winding core has a quadrilateral prism shape. One of the two flanges is connected to one side of the winding core, and the other flange is connected to the other side of the winding core. Each flange protrudes from the winding core outward in a direction perpendicular to the central axis line of the winding core. The core is made of a magnetic material. The coil component also includes a top plate. The top plate has a substantially rectangular planar shape. The top plate is connected to the core so as to link the two flanges therebetween like a bridge. The coil component includes an adhesive. The adhesive is interposed between the top plate and the core and bonds the top plate and the core with each other. The adhesive contains magnetic powder.

### SUMMARY

The adhesive used in the coil component disclosed in the above-described publication contains magnetic powder, so that the permeability of the adhesive becomes higher than an adhesive without magnetic powder. Nevertheless, magnetic powder contained in an adhesive does not contribute to enhancing the adhesion strength of the adhesive. The adhesive containing many magnetic powders may be broken from the inside starting from the interfaces of the magnetic powders, that is, cohesive failure may occur.

To address the above-described issue, an aspect of the present disclosure provides a coil component including a first core, a second core, a wire wound around the first core, and an adhesive. The adhesive is interposed between the first core and the second core and bonds the first core and the second core with each other. The adhesive includes a synthetic resin, magnetic powder, and a curing agent for the synthetic resin. A cross section perpendicular to an adhesion surface between the adhesive and the first core is set to a specific cross section. A direction perpendicular to the adhesion surface is set to a thickness direction. A direction perpendicular to the thickness direction in the specific cross section is set to an extending direction. The adhesive includes a resin portion in the specific cross section. The resin portion is a portion which does not contain the magnetic powder in the thickness direction in a range between the first core and the second core and which is continuously disposed by 3 μm or larger in the extending direction.

With the above-described configuration, cohesive failure, such as a phenomenon in which the second core is separated from the first core, is less likely to occur in the adhesive.

### BRIEF DESCRIPTION OF THE DRAWINGS

FIG. 1 is a perspective view of a coil component;

FIG. 2 is an exploded perspective view of the coil component;

FIG. 3 is a schematic view of an adhesive in an uncured state; and

FIG. 4 is a sectional view of the coil component in a specific cross section.

### DETAILED DESCRIPTION

An embodiment of a coil component will be described below with reference to the drawings. For easy understanding of the embodiment, elements may be shown in enlarged size in the drawings. The dimensional ratio of elements in one drawing may be different from that in another drawing or that of actual elements.

### (Overall Configuration of Coil Component)

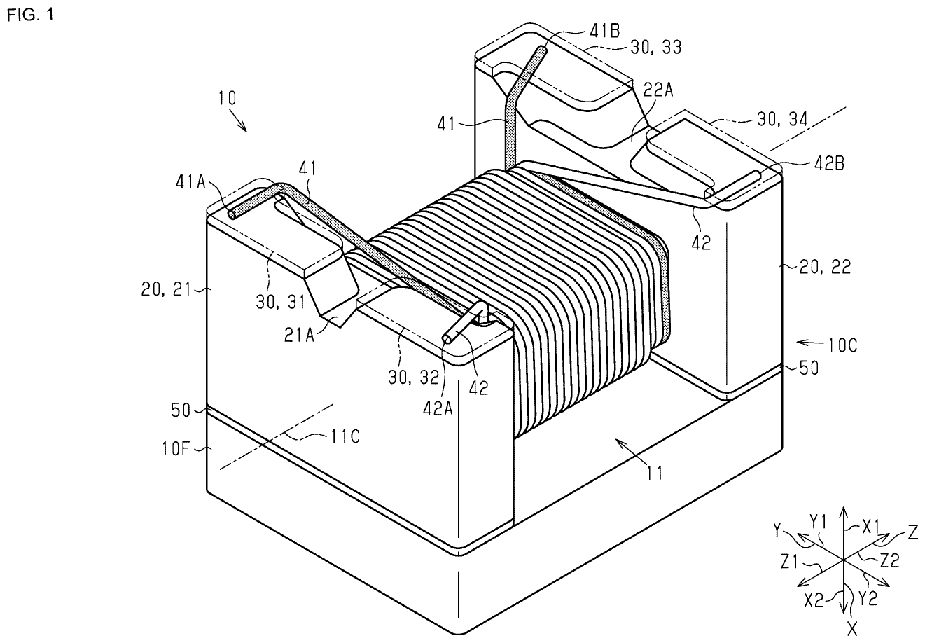

As illustrated in FIG. 1, a coil component 10 includes a drum core 10C, which serves as a first core, and a top plate 10F, which serves as a second core.

The drum core 10C includes a winding core 11. The winding core 11 has a quadrilateral prism shape having a central axis line 11C. Across section of the winding core 11 perpendicular to the central axis line 11C has a rectangular shape. In the embodiment, “rectangular shape” includes a roughly rectangular shape having four sides, such as a rectangle having chamfered corners. Examples of the material for the winding core 11 are alumina, Ni—Zn ferrite, synthetic resin, and a mixture of these substances. In the embodiment, the material of the winding core 11 is Ni—Zn ferrite, which is one type of magnetic material.

A specific axis perpendicular to the central axis line 11C of the winding core 11 is set to a first axis X. In the embodiment, when the winding core 11 is seen in a direction along the central axis line 11C, the first axis X is parallel with the two short sides of the winding core 11. An axis perpendicular to both of the first axis X and the central axis line 11C is set to a second axis Y In the embodiment, when the winding core 11 is seen in a direction along the central axis line 11C, the second axis Y is parallel with the two long sides of the winding core 11. An axis parallel with the central axis line 11C is set to a third axis Z. One of the directions along the first axis X is set to a first positive direction X1, while the opposite direction of the first positive direction X1 is set to a first negative direction X2. Likewise, one of the directions along the second axis Y is set to a second positive direction Y1, while the opposite direction of the second positive direction Y1 is set to a second negative direction Y2. One of the directions along the third axis Z is set to a third positive direction Z1, while the opposite direction of the third positive direction Z1 is set to a third negative direction Z2.

As illustrated in FIG. 1, the drum core 10C includes two flanges 20: one flange 20 is connected to one side of the winding core 11 and the other flange 20 is connected to the other side of the winding core 11, as is seen in the direction along the central axis line 11C. The two flanges 20 are specifically a first flange 21 and a second flange 22. The first flange 21 is connected to a first end of the winding core 11, which is the end of the third positive direction Z1. The first flange 21 has a flat, substantially quadrilateral planar shape. The thickness direction of the first flange 21 is a direction along the third axis Z. When the first flange 21 is seen in a direction along the third axis Z, the individual sides of the first flange 21 are substantially parallel with the individual sides of the winding core 11. The first flange 21 protrudes outward with respect to the outer surfaces of the winding core 11 in the direction along the first axis X and the direction along the second axis Y That is, when the first flange 21 is seen in the direction along the third axis Z, the first flange 21 protrudes all around 360 degrees with respect to the outer surfaces of the winding core 11.

The first flange 21 has a first hollow 21A. The first hollow 21A is recessed with respect to the end surface of the first flange 21 in the first positive direction X1. The first hollow 21A is located at the center of the first flange 21 along the direction of the second axis Y The first hollow 21A is opened at both sides of the first flange 21 in the direction along the third axis Z. With this configuration, the end surface of the first flange 21 in the first positive direction X1 is divided into two portions with the first hollow 21A therebetween.

The second flange 22 is connected to a second end of the winding core 11, which is the end of the third negative direction Z2. The shape of the second flange 22 is plane-symmetrical to that of the first flange 21. That is, the second flange 22 has a substantially quadrilateral planar shape. The second flange 22 protrudes outward with respect to the outer surfaces of the winding core 11 in the direction along the first axis X and the direction along the second axis Y That is, when the second flange 22 is seen in the direction along the third axis Z, the second flange 22 protrudes all around 360 degrees with respect to the outer surfaces of the winding core 11. The second flange 22 has a second hollow 22A, which is similar to the first hollow 21A of the first flange 21. The material of the first and second flanges 21 and 22 is Ni—Zn ferrite, which is the same material for the winding core 11. That is, the drum core 10C is made of a magnetic material. The first and second flanges 21 and 22 are integrally formed with the winding core 11.

The top plate 10F has a flat, rectangular planar shape. The thickness direction of the top plate 10F is a direction along the first axis X. The long sides of the top plate 10F are parallel with the third axis Z. The short sides of the top plate 10F are parallel with the second axis Y The top plate 10F is located in the first negative direction X2 with respect to the drum core 10C. The top plate 10F is connected to the surface of the first flange 21 which faces in the first negative direction X2 and is also connected to the surface of the second flange 22 which faces in the first negative direction X2. That is, the top plate 10F is connected to the drum core 10C so as to link the first and second flanges 21 and 22 therebetween like a bridge. The material of the top plate 10F is the same as the material of the winding core 11. That is, the top plate 10F is made of Ni—Zn ferrite, which is one type of magnetic material. The top plate 10F forms a closed magnetic path, together with the drum core 10C. In the embodiment, the top plate 10F around which wires, which will be discussed later, are not directly wound and elements of the drum core 10C, such as the flanges 20, around which the wires are not wound, are also regarded as a core or part of the core.

The coil component 10 includes an adhesive 50. The adhesive 50 is interposed between the drum core 10C and the top plate 10F. That is, the adhesive 50 bonds the drum core 10C and the top plate 10F with each other. In other words, the top plate 10F is connected to the two flanges 20 via the adhesive 50. In the embodiment, the drum core 10C and the top plate 10F directly contact the adhesive 50. Details of the adhesive 50 will be discussed later.

The coil component 10 includes four outer electrodes 30. More specifically, the coil component 10 includes a first electrode 31, a second electrode 32, a third electrode 33, and a fourth electrode 34. Among the outer surfaces of the first flange 21, the first electrode 31 is located on the end surface positioned toward the first positive direction X1. Among the outer surfaces of the first flange 21, the first electrode 31 is also located toward the second positive direction Y1 with respect to the central axis line 11C. More specifically, the first electrode 31 is located toward the second positive direction Y1 with respect to the first hollow 21A.

Among the outer surfaces of the first flange 21, the second electrode 32 is located on the end surface positioned toward the first positive direction X1. Among the outer surfaces of the first flange 21, the second electrode 32 is also located toward the second negative direction Y2 with respect to the central axis line 11C. More specifically, the second electrode 32 is located toward the second negative direction Y2 with respect to the first hollow 21A.

Among the outer surfaces of the second flange 22, the third electrode 33 is located on the end surface positioned toward the first positive direction X1. Among the outer surfaces of the second flange 22, the third electrode 33 is also located toward the second positive direction Y1 with respect to the central axis line 11C. More specifically, the third electrode 33 is located toward the second positive direction Y1 with respect to the second hollow 22A.

Among the outer surfaces of the second flange 22, the fourth electrode 34 is located on the end surface positioned toward the first positive direction X1. Among the outer surfaces of the second flange 22, the fourth electrode 34 is also located toward the second negative direction Y2 with respect to the central axis line 11C. More specifically, the fourth electrode 34 is located toward the second negative direction Y2 with respect to the second hollow 22A.

The outer electrode 30 has a metal layer and a plated layer, which are not shown. The material of the metal layer is silver. The metal layer is formed on the outer surface of each of the first and second flanges 21 and 22. The plated layer is constituted by three layers. The plated layer is constituted by copper, nickel, and tin layers stacked on the surface of the metal layer in this order. The end surface of the coil component 10 located toward the first positive direction X1 serves as a mounting surface at the time of the mounting of the coil component 10 on a substrate.

As shown in FIG. 1, the coil component 10 includes a first wire 41 and a second wire 42. The first and second wires 41 and 42 are wound around the winding core 11 of the drum core 10C.

The first wire 41 has a copper wire and an insulating coating, which are not shown. The insulating coating covers the outer surface of the copper wire. The first wire 41 is substantially circular in a cross section perpendicular to the extending direction of the first wire 41. The configuration of the second wire 42 is the same as that of the first wire 41. That is, the second wire 42 has a copper wire and an insulating coating. In FIG. 1, the first wire 41 is indicated by a dot pattern.

A first end 41A of the first wire 41 is connected to the first electrode 31. A second end 41B of the first wire 41 is connected to the third electrode 33. The first and second ends 41A and 41B are thermally pressure-bonded to the corresponding outer electrodes 30.

When the first wire 41 is seen in the third negative direction Z2, it is wound around the winding core 11 clockwise from the first end 41A to the second end 41B.

A first end 42A of the second wire 42 is connected to the second electrode 32. A second end 42B of the second wire 42 is connected to the fourth electrode 34. The first and second ends 42A and 42B are thermally pressure-bonded to the corresponding electrodes.

When the second wire 42 is seen in the third negative direction Z2, it is wound around the winding core 11 clockwise from the first end 42A to the second end 42B. That is, the second wire 42 is wound in the same direction as the first wire 41. The second wire 42 is wound on the outer side of the first wire 41 around the winding core 11.

### (Adhesive)

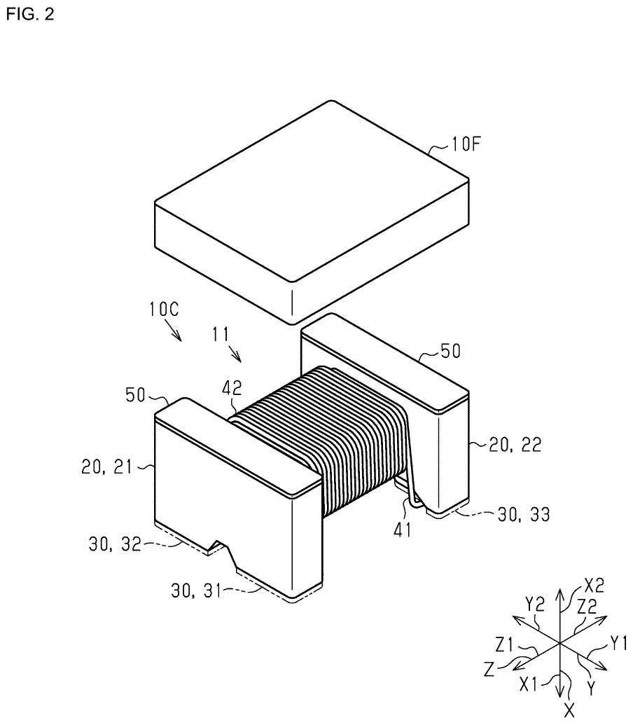

As shown in FIG. 2, the adhesive 50 covers the entire surface of the first flange 21 which faces in the first negative direction X2. The adhesive 50 connects the first flange 21 and the top plate 10F with each other without any gap therebetween. Likewise, the adhesive 50 covers the entire surface of the second flange 22 which faces in the first negative direction X2. The adhesive 50 connects the second flange 22 and the top plate 10F with each other without any gap therebetween. That is, the top plate 10F is connected to the two flanges 20.

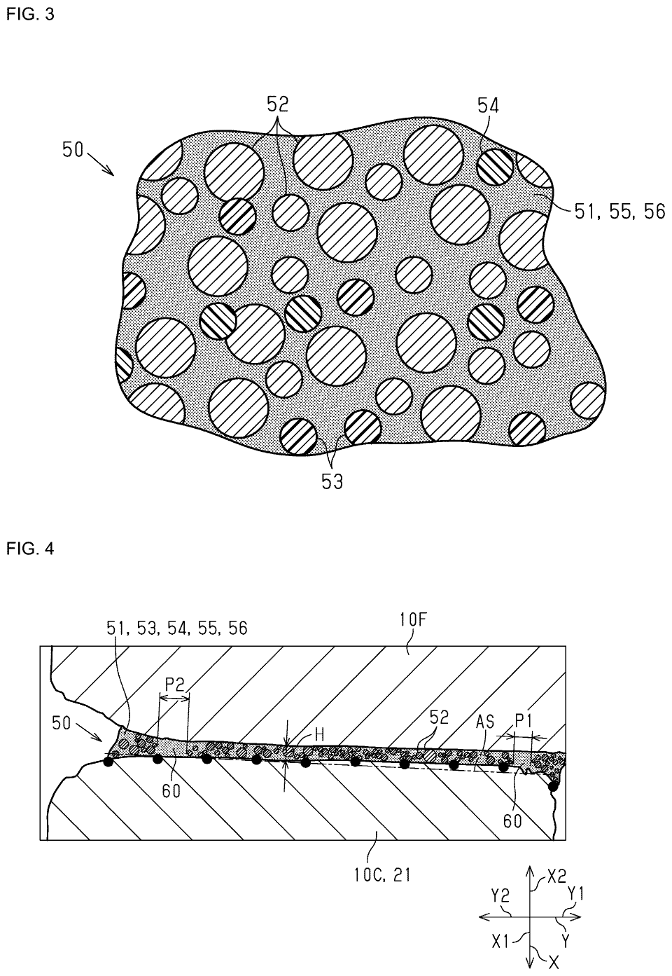

As illustrated in FIG. 3, the adhesive 50 includes a bisphenol F resin 51 as a synthetic resin. The adhesive 50 also includes magnetic powders 52, a curing agent 53, a curing accelerator 54, a silane coupling agent 55, and a dispersant 56. The adhesive 50 shown in FIG. 3 is in a state in which it is not yet cured. In FIG. 3, only some magnetic powders 52 and only part of each of the curing agent 53 and the curing accelerator 54 are appended with reference numerals.

Specifically, the adhesive 50 is manufactured as follows. First, the bisphenol F resin 51, curing agent 53, curing accelerator 54, silane coupling agent 55, dispersant 56, and magnetic powders 52 were mixed with a kneader (model type: HIVIS MIX (registered trademark) 2P-03 (made by PRIMIX Corporation)) at 30 rpm for five minutes. Then, the resulting mixture was kneaded with a dispersing machine (model type: EXAKT 80E (made by Nagase Screen Printing Research Co., Ltd.)) at a clearance of 6 μm and at 230 rpm. As a result, the uncured adhesive 50 was manufactured.

In the embodiment, the bisphenol F resin 51 is a bisphenol F epoxy resin, and more specifically, it is CAS No. 9003-36-5. In the embodiment, the resin is collectively called the bisphenol F resin 51 regardless of whether it is a monomer or a polymer.

The number average molecular weight of the bisphenol F resin 51 is 312 g/mol. The number average molecular weight can be measured with GPC (model type: HLC-8120GPC (made by Tosoh Techno-System Inc.)). GPC stands for Gel Permeation Chromatography. For the measurements using this machine, the temperature of columns was set to 40° C., and tetrahydrofuran was used as a solvent. The flow rate of a solution including the solvent was set to 1.0 ml/min. Monodisperse polystyrene was used as a standard sample.

In the embodiment, the magnetic powders 52 are nickel powders, and more specifically, it is CAS No. 7440-02-0. The magnetic powders 52 contain particles having particle sizes of 0.1 μm to 11 μm. In the embodiment, the magnetic powders 52 contain particles having particle sizes of 0.1 μm to 3.0 μm. The particle size of a magnetic powder 52 is calculated as follows. First, a cross section of the adhesive 50 is examined with an electron microscope. Then, the examined range of the cross section is subjected to image processing so as to obtain the outlines of the magnetic powders 52. The area of one magnetic powder 52 is then calculated. A circle having the calculated area is determined. The diameter of this circle is calculated as the particle size of the magnetic powder 52.

In a particle size distribution of the magnetic powders 52, the median particle size (D50) is 0.5 μm to 0.96 μm. The median particle size (D50) of the magnetic powders 52 is calculated as follows, for example. First, samples of the magnetic powders 52 are selected with a scanning electron microscope so as to obtain the particle size distribution. Then, in the particle size distribution, in order of the smallest to the largest particle sizes, the frequency of each particle size is accumulated and the particle size whose accumulated value is 50% is set to the median particle size (D50).

The curing agent 53 is that for the bisphenol F resin 51. In the embodiment, the curing agent 53 is dicyandiamide, and more specifically, it is CAS No. 461-58-5.

The curing accelerator 54 is that for the bisphenol F resin 51. In the embodiment, the curing accelerator 54 is amine adduct, and more specifically, it is CAS No. 134091-75-1.

The dispersant 56 is used for dispersing the magnetic powders 52 in the adhesive 50. In the embodiment, the dispersant 56 is a carboxyl-group-containing polymer modified substance, and more specifically, a carboxyl-group-containing polymer modified substance having an acid value of 55 mgKOH/g.

In the embodiment, the silane coupling agent 55 is glycidoxypropyltrimethoxysilane, and more specifically, it is CAS No. 253-83-8.

### (Cross Section of Adhesive in Coil Component)

The adhesive 50 used in the coil component 10 is in the cured state. The adhesive 50 is cured after it is burned at 100 degrees, for example. In the adhesive 50 in the cured state, the bisphenol F resin 51, curing agent 53, and curing accelerator 54 are polymerized. In the adhesive 50, the magnetic powders 52 are dispersed in the cured polymer containing the bisphenol F resin 51 as a principal component.

As illustrated in FIG. 4, a cross section perpendicular to an adhesion surface AS between the adhesive 50 and the drum core 10C is set to a specific cross section. In the embodiment, the specific cross section is a cross section along the first axis X and the second axis Y.

The direction perpendicular to the adhesion surface AS is set to a thickness direction. In the specific cross section, the direction perpendicular to the thickness direction is set to an extending direction. In the embodiment, the definition of the adhesion surface AS is as follows. First, in a cross section including the adhesive 50 and the drum core 10C, in the area where the adhesive 50 and the drum core 10C contact each other, ten contact points of the adhesive 50 and the drum core 10C are set at equal spacings. In FIG. 4, these ten contact points are indicated by the black dots. Then, the approximate straight line of the ten contact points is calculated by the least squares method, for example. Then, a surface along the calculated approximate straight line is determined to be the adhesion surface AS. The thickness direction perpendicular to the adhesion surface AS may be inclined with respect to the first axis X.

In the specific cross section, as viewed in the extending direction, the dimension of the end portions of the adhesive 50 in the thickness direction is slightly larger than that of the central portion of the adhesive 50 in the thickness direction. In the specific cross section, the average dimension H of the adhesive 50 in the thickness direction is 1 μm to 11 μm. The average dimension H of the adhesive 50 in the thickness direction is calculated as follows. First, an image of the specific cross section is captured with an electron microscope. Then, in the captured image, a range in a direction along the outer surface of the adhesive 50 on the side of the drum core 10C is determined. From this range, a measurement range having at least 5 μm or larger is determined, and the cross-sectional area of the adhesive 50 in the measurement range is calculated by image processing. Then, the calculated cross-sectional area of the adhesive 50 is divided by the dimension of the measurement range. As a result, the dimension of the adhesive 50 in the thickness direction is calculated. That is, the average dimension H of the adhesive 50 in the thickness direction is the dimension in the measurement range. The average dimension H shown in FIG. 4 is an example and the average dimension H is not limited thereto.

As illustrated in FIG. 4, in the specific cross section, the adhesive 50 includes two resin portions 60. In the specific cross section, each resin portion 60 is a portion which does not contain magnetic powders 52 in the thickness direction in a range between the drum core 10C and the top plate 10F and which is continuously disposed by 3 μm or larger in the extending direction. In other words, the resin portion 60 is a portion where the smallest distance between magnetic powders 52 is 3 μm or larger in the extending direction. In the embodiment, a portion without magnetic powders 52 is a portion where magnetic powders 52 are not detected in a backscattered electron image of the specific cross section examined with a scanning electron microscope at 1000× magnification. In the embodiment, the resin portion 60 includes the bisphenol F resin 51 as a principal component and also includes the curing agent 53, curing accelerator 54, silane coupling agent 55, and dispersant 56. The curing agent 53, curing accelerator 54, silane coupling agent 55, and dispersant 56 may be contained in the resin portion 60 as unreacted substances in one case or may be polymerized with the bisphenol F resin 51 in another case.

In the specific cross section, one of the two resin portions 60 is located near the end portion of the adhesive 50 in the second positive direction Y1, while the other resin portion 60 is located near the end portion of the adhesive 50 in the second negative direction Y2. That is, in the extending direction, one resin portion 60 is located at one side of the adhesive 50 and the other resin portion 60 is located at the other side of the adhesive 50 with the center of the adhesive 50 therebetween. The length P1 of one of the two resin portions 60 in the extending direction is about 7 μm. The length P2 of the other resin portion 60 in the extending direction is about 15 μm. The lengths P1 and P2 of the resin portions 60 are examples and may be other values if they are 3 μm or larger.

In the specific cross section, the proportion of the resin portions 60 in the adhesive 50 is 10% or higher. The proportion of the resin portions 60 in the adhesive 50 is calculated as follows. First, an image of the specific cross section is captured with a scanning electron microscope. Then, in the captured image, two points at end portions in the extending direction on the adhesion surface AS with the drum core 10C are determined. Then, the length between the two points in the extending direction in the captured image is determined. In the captured image, the total length of the resin portions 60 in the extending direction is determined. The determined total length of the resin portions 60 is then divided by the length between the two points at the end portions of the adhesion surface AS, and the resulting value is set to the proportion of the resin portions 60 in the adhesive 50.

In the specific cross section, the proportion of the magnetic powders 52 in the adhesive 50 is 20% to 40%. The proportion of the magnetic powders 52 in the adhesive 50 is calculated as follows. First, an examination image of the specific cross section is obtained from a backscattered electron image of the specific cross section captured by a scanning electron microscope at 1000× magnification. Then, the obtained examination image is binarized. Morphological processing, more specifically, erosion processing, is performed on the examination image one time so as to determine the outer edges of the magnetic powders 52. Subsequently, in the examination image, the total cross-sectional area of the magnetic powders 52 and the cross-sectional area of the entire adhesive 50 are calculated by image processing. The total cross-sectional area of the magnetic powders 52 is then divided by the cross-sectional area of the entire adhesive 50. As a result, the proportion of the magnetic powders 52 in the adhesive 50 is calculated.

(Growth of Resin Portions during Curing Process of Adhesive)

In one step of the manufacturing process of the coil component 10, the adhesive 50 in the uncured state is applied to the drum core 10C. More specifically, the uncured adhesive 50 is applied to the substantially entirety of the end surface of the first flange 21 facing in the first negative direction X2 and to the substantially entirety of the end surface of the second flange 22 facing in the first negative direction X2. Then, the top plate 10F is bonded to the drum core 10C with the adhesive 50 therebetween. Then, the drum core 10C with the top plate 10F bonded thereto using the adhesive 50 is burned at 100° C. or higher. At a temperature of around 100° C., the bisphenol F resin 51 starts to be cured mainly with the aid of the curing agent 53. The bisphenol F resin 51 is then expanded to be cured during the curing process while scattering away magnetic powders 52. As a result, a resin portion 60 which does not contain magnetic powders 52 between the drum core 10C and the top plate 10F and which is continuously disposed by 3 μm or larger in the extending direction is formed.

As stated above, in the specific cross section, as viewed in the extending direction, the dimension of the end portions of the adhesive 50 in the thickness direction is slightly larger than that of the central portion of the adhesive 50 in the thickness direction. Hence, the bisphenol F resin 51 is likely to accumulate in the end portions of the uncured adhesive 50. As a result, the resin portions 60 are likely to be formed in the vicinity of the end portions of the adhesive 50 in the extending direction in the specific cross section.

### Advantages of Embodiment

(1) In the embodiment, the adhesive 50 includes the magnetic powders 52 and thus has a higher permeability than that without the magnetic powders 52. In the adhesive 50 configured as described above, the resin portions 60 do not contain magnetic powders 52. A resin portion 60 is continuously disposed by 3 μm or larger in the extending direction. In this manner, with the presence of a resin portion 60 in the form of a mass having a considerable length without the interface with magnetic powders 52, the adhesion strength of the drum core 10C and the top plate 10F can be secured by this resin portion 60. In other words, cohesive failure, such as a phenomenon in which the top plate 10F is separated from the drum core 10C, is less likely to occur in the adhesive 50.
(2) In the embodiment, the magnetic powders 52 contain particles having particle sizes of 0.1 μm to 11 μm. Containing the magnetic powders 52 having such particle sizes can enhance the permeability of the adhesive 50.
(3) In the embodiment, the top plate 10F is connected to the two flanges 20 via the adhesive 50. That is, in the embodiment, the coil component 10 has a closed magnetic path formed by the drum core 10C and the top plate 10F. Using the adhesive 50 of the embodiment to bond the drum core 10C and the top plate 10F, which form a closed magnetic path, with each other is desirable for enhancing the characteristics of the coil component 10 as a whole.
(4) In the embodiment, the drum core 10C and the top plate 10F directly contact the adhesive 50. If another member is interposed between the adhesive 50 and the drum core 10C, a certain structure for bonding this member and the drum core 10C is required. That is, with the above-described configuration, an additional structure for bonding another member and the drum core 10C is not necessary, which does not increase the dimensions of the coil component 10. Likewise, the top plate 10F and the adhesive 50 directly contact each other, whereby similar advantages can be obtained.
(5) In the embodiment, in the specific cross section, the proportion of the resin portions 60 in the adhesive 50 is 10% or higher. With this proportion of the resin portions 60 in the adhesive 50, the occurrence of cohesive failure in the adhesive 50 can be reduced more effectively.
(6) In the embodiment, in the specific cross section, the proportion of the magnetic powders 52 in the adhesive 50 is 20% to 40%. With this range of the proportion of the magnetic powders 52 in the adhesive 50 including the resin portions 60, the adhesive 50 can achieve a high permeability while securing the adhesion strength.
(7) In the embodiment, the adhesive 50 includes an epoxy resin as the synthetic resin and also includes dicyandiamide as the curing agent. Using these materials can efficiently form the resin portions 60.
(8) In the embodiment, the synthetic resin included in the adhesive 50 is a bisphenol F epoxy resin. This can regulate a rise in the viscosity of the uncured adhesive 50. Bubbles are thus less likely to be generated at the interface between the adhesive 50 and each of the drum core 10C and the top plate 10F.
(9) In the embodiment, particles having small particle sizes of the magnetic powders 52 can improve a filling rate of the magnetic powders 52 in the adhesive 50, but may weaken the magnetization in the adhesive 50 because of the increased particle interfaces. In the embodiment, the median particle size (D50) of the magnetic powders 52 is 0.5 μm to 0.96 μm. With this range of the median particle size (D50), the filling rate of the magnetic powders 52 in the adhesive 50 can be improved. Additionally, in the embodiment, it is highly likely that the magnetic powders 52 include particles having relatively large particle sizes of 0.96 μm or larger. This makes it less likely to weaken the magnetization in the adhesive 50.
(10) In the embodiment, in the specific cross section, the average dimension H of the adhesive 50 in the thickness direction is 1 μm to 11 μm. An excessively large dimension of the adhesive 50 in the thickness direction makes it difficult to form a resin portion 60 extending from the drum core 10C to the top plate 10F. Conversely, an excessively small dimension of the adhesive 50 in the thickness direction may lower the adhesion strength. Such issues can be effectively addressed by above-described configuration.
(11) In the embodiment, in the specific cross section, a resin portion 60 is disposed at both sides of the adhesive 50 with the center of the adhesive 50 therebetween in the extending direction. Because of the presence of the resin portion 60 having a relatively high adhesion strength at both sides of the adhesive 50, an unbalanced state, such as the adhesion strength is high at one side of the adhesive 50 and is low at the other side of the adhesive 50, is unlikely to occur. That is, the adhesion strength of the adhesive 50 can be made uniform, thereby preventing the separation of the adhesive 50 starting from a portion having a low adhesion strength.

### Modified Examples

The above-described embodiment and the following modified examples may be combined with each other in a suitable manner and be carried out as long as the resulting configurations do not become technically inconsistent.

### (Modified Examples of Coil Component)

The shape of the winding core 11 is not limited to the example in the embodiment. For instance, the shape of the winding core 11 may be a cylinder or a polygonal prism other than a quadrilateral prism.

The configuration of the drum core 10C is not limited to the example in the embodiment. For instance, the provision of the first hollow 21A and the second hollow 22A for the drum core 10C may be omitted if the first electrode 31 and the second electrode 32 are separated from each other and the third electrode 33 and the fourth electrode 34 are separated from each other, for example. The drum core 10C may include at least the winding core 11 and the flanges 20.

The material and the shape of the outer electrodes 30 are not limited to the examples in the embodiment. In one example, the material of the plated layer of the outer electrodes 30 may be an alloy of tin and nickel, for example. In another example, the provision of the plated layer for the outer electrodes 30 may be omitted. In this case, a portion where a metal layer having conductivity is exposed may be used as the outer electrode 30.

The coil component 10 may include at least one wire. If the coil component 10 includes one wire, any number of outer electrodes 30 may be provided if one outer electrode 30 is disposed on the first flange 21 and one outer electrode 30 is disposed on the second flange 22.

The configuration of the coil component 10 is not limited to that constituted by the drum core 10C and the top plate 10F. The coil component 10 may be configured in any manner as long as it includes a first core around which a wire is wound and a second core connected to the first core via the adhesive 50 and the first core and the second core are bonded with each other by the adhesive 50. Additionally, it is not essential that each of the drum core 10C and the top plate 10F directly contacts the adhesive 50. For example, a planar metal terminal may be fixed to each of the first and second flanges 21 and 22 of the drum core 10C and the adhesive 50 may be applied onto the metal terminal. That is, even in the configuration in which the drum core 10C contacts the adhesive 50 with another member therebetween, it can also be assumed that the adhesive 50 bonds the drum core 10C and the top plate 10F with each other. Likewise, even in the configuration in which the top plate 10F contacts the adhesive 50 with another member therebetween, it can also be assumed that the adhesive 50 bonds the drum core 10C and the top plate 10F with each other.

The material of the drum core 10C and the top plate 10F is not limited to a magnetic material. For example, a non-magnetic material, such as alumina and synthetic resin, may be used.

In the specific cross section, the average dimension H of the adhesive 50 in the thickness direction may be smaller than 1 μm or larger than 11 μm.

In the specific cross section, the proportion of the resin portions 60 in the adhesive 50 may be lower than 10%. Additionally, in the embodiment, at least one resin portion 60 in the specific cross section may be sufficient.

The specific cross section is not limited to the example in the embodiment. For instance, it is possible that the specific cross section is not a cross section along the second axis Y A cross section perpendicular to the adhesion surface between the adhesive 50 and the second flange 22 may be set to the specific cross section.

In the embodiment, if a resin portion 60 is observed in at least one specific cross section, it is assumed that the adhesive 50 includes a resin portion 60 in the specific cross section. For example, if a resin portion 60 has a cylindrical shape, the smallest distance between magnetic powders 52 in the extending direction may be smaller than 3 μm in a certain specific cross section. In even such a case, if the smallest distance between magnetic powders 52 in the extending direction is 3 μm or larger in another specific cross section, it is assumed that the adhesive 50 includes a resin portion 60. To more effectively reduce the occurrence of cohesive failure in the adhesive 50, such as a phenomenon in which the drum core 10C and the top plate 10F are separated from each other, it is preferable that the smallest distance between magnetic powders 52 in the extending direction be 3 μm or larger also in a cross section perpendicular to the adhesion surface AS and perpendicular to the specific cross section. That is, it is more preferable that the shape of the resin portion 60 is a cylinder having a diameter of 3 μm or larger or a prism, such as a quadrilateral prism, having a side of 3 μm or larger.

### (Modified Examples of Adhesive)

The adhesive 50 may include at least a synthetic resin, magnetic powders 52, and curing agent 53. The types of synthetic resin, magnetic powders 52, and curing agent 53 are not limited to the examples in the embodiment. The type of curing agent 53 may be any type if it is compatible with the synthetic resin in the adhesive 50. For example, in the embodiment, amine adduct may be used as the curing agent 53, and the curing accelerator 54 may be omitted.

The number average molecular weight of the bisphenol F resin 51 in the adhesive 50 is not limited to the example in the embodiment. A bisphenol F resin 51 having a suitable number average molecular weight may be used in view of the properties of the adhesive 50, such as the adhesion strength and the viscosity.

The silane coupling agent 55, dispersant 56, and curing accelerator 54 may be omitted from the adhesive 50. The types of silane coupling agent 55, dispersant 56, and curing accelerator 54 are not limited to the examples in the embodiment.

The median particle size (D50) of the magnetic powders 52 in the adhesive 50 may be smaller than 0.5 μm or larger than 0.96 μm.

It is not essential that the magnetic powders 52 contain particles having particle sizes of 0.1 μm to 11 μm. That is, all the particle sizes of the magnetic powders 52 may be smaller than 0.1 μm or larger than 11 μm.

In the specific cross section, the proportion of the magnetic powders 52 in the adhesive 50 may be lower than 20% or higher than 40%. A suitable proportion of the magnetic powders 52 in the adhesive 50 may be selected in view of the properties of the adhesive 50, such as the overall permeability and adhesion strength.

### Appendix

The technical concept that can be derived from the above-described embodiment and modified examples is as follows.
[1] A coil component comprising a first core; a second core; a wire wound around the first core; and an adhesive that is interposed between the first core and the second core and that bonds the first core and the second core with each other. The adhesive includes a synthetic resin, magnetic powder, and a curing agent for the synthetic resin. A cross section perpendicular to an adhesion surface between the adhesive and the first core is set to a specific cross section, a direction perpendicular to the adhesion surface is set to a thickness direction, and a direction perpendicular to the thickness direction in the specific cross section is set to an extending direction. Also, the adhesive includes a resin portion in the specific cross section, the resin portion being a portion which does not contain the magnetic powder in the thickness direction in a range between the first core and the second core and which is continuously disposed by 3 μm or larger in the extending direction.
[2] The coil component according to [1], wherein the magnetic powder includes particles having particle sizes of 0.1 μm to 11 μm.
[3] The coil component according to [1] or [2], wherein the first core includes a winding core and two flanges, the winding core having a columnar or polygonal-prism shape having a central axis line, one of the two flanges being connected to one side of the winding core and the other one of the two flanges being connected to the other side of the winding core, the sides of the winding core being sides in a direction along the central axis line; and the second core is connected to the two flanges via the adhesive.
[4] The coil component according to one of [1] to [3], wherein the first core and the second core directly contact the adhesive.
[5] The coil component according to one of [1] to [4], wherein, in the specific cross section, a proportion of the resin portion in the adhesive is 10% or higher.
[6] The coil component according to one of [1] to [5], wherein, in the specific cross section, a proportion of the magnetic powder in the adhesive is 20% to 40%.
[7] The coil component according to one of [1] to [6], wherein the synthetic resin is an epoxy resin; and the curing agent includes at least one of dicyandiamide and amine adduct.
[8] The coil component according to [7], wherein the synthetic resin is a bisphenol F epoxy resin.
[9] The coil component according to one of [1] to [8], wherein a median particle size (D50) of the magnetic powder is 0.5 μm to 0.96 μm.
[10] The coil component according to one of [1] to [9], wherein, in the specific cross section, an average dimension of the adhesive in the thickness direction is 1 μm to 11 μm.

What is claimed is:

1. A coil component comprising:
a first core;
a second core;
a wire wound around the first core; and
an adhesive that is interposed between the first core and the second core and that bonds the first core and the second core with each other, wherein
the adhesive includes a synthetic resin, magnetic powder, and a curing agent for the synthetic resin,
a cross section perpendicular to an adhesion surface between the adhesive and the first core is defined as a specific cross section, a direction perpendicular to the adhesion surface is defined as a thickness direction, and a direction perpendicular to the thickness direction in the specific cross section is defined as an extending direction,
the adhesive includes a resin portion in the specific cross section, and
the resin portion is a portion which does not contain the magnetic powder in the thickness direction in a range between the first core and the second core, and is continuously disposed by 3 μm or greater in the extending direction.

2. The coil component according to claim 1, wherein
the magnetic powder includes particles having particle sizes of from 0.1 μm to 11 μm.

3. The coil component according to claim 1, wherein:
the first core includes a winding core and two flanges,
the winding core has a columnar or polygonal-prism shape having a central axis line,
the two flanges is connected to opposite ends of the winding core in a direction along the central axis line of the winding core; and
the second core is connected to the two flanges via the adhesive.

4. The coil component according to claim 1, wherein
the first core and the second core directly contact the adhesive.

5. The coil component according to claim 1, wherein
in the specific cross section, a proportion of the resin portion in the adhesive is 10% or greater.

6. The coil component according to claim 1, wherein
in the specific cross section, a proportion of the magnetic powder in the adhesive is from 20% to 40%.

7. The coil component according to claim 1, wherein:
the synthetic resin is an epoxy resin; and
the curing agent includes at least one of dicyandiamide and amine adduct.

8. The coil component according to claim 7, wherein
the synthetic resin is a bisphenol F epoxy resin.

9. The coil component according to claim 1, wherein
a median particle size (D50) of the magnetic powder is from 0.5 μm to 0.96 μm.

10. The coil component according to claim 1, wherein
in the specific cross section, an average dimension of the adhesive in the thickness direction is from 1 μm to 11 μm.
